(19) United States
(12) Patent Application Publication
(10) Pub. No.: US 2014/0169449 A1
(43) Pub. Date: Jun. 19, 2014

(54) REFERENCE PICTURE MANAGEMENT FOR LAYERED VIDEO

(71) Applicants: Jonatan Samuelsson, Stockholm (SE); Rickard Sjöberg, Stockholm (SE)

(72) Inventors: Jonatan Samuelsson, Stockholm (SE); Rickard Sjöberg, Stockholm (SE)

(73) Assignee: Telefonaktiebolaget L M Ericsson (PUBL), Stockholm (SE)

(21) Appl. No.: 14/131,191

(22) PCT Filed: May 4, 2012
(86) PCT No.: PCT/SE2012/050471

§ 371 Date: Jan. 6, 2014

Related U.S. Application Data
(60) Provisional application No. 61/504,482, filed on Jul. 5, 2011.

(51) Int. Cl. H04N 19/105; H04N 19/30

(52) U.S. Cl. CPC H04N 19/00024; H04N 19/00424
USPC 375/240.02

(57) ABSTRACT

An encoded representation (60) of a picture (10) of a video stream (1) is decoded by retrieving buffer description information defining at least one reference picture (40, 42). The buffer description information is used to determine a picture identifier of a reference picture (40, 42), which is compared to picture identifiers of reference pictures (40, 42) stored in a decoded picture buffer (230, 350). If the reference picture (40, 42) is determined to be missing based on the comparison of picture identifiers the layer identifier of the reference picture (40, 42) obtained based on the buffer description information is compared to a layer identifier of the current picture (10) in order to determine whether the missing reference picture (40, 42) has been intentionally removed or is unintentionally lost.

### TECHNICAL FIELD

The embodiments generally relate to reference picture management in connection with video encoding and decoding, and in particular to reference picture management for layered video.

### BACKGROUND

H.264, also referred to as Moving Picture Experts Group-4 (MPEG-4) Advanced Video Coding (AVC), is the state of the art video coding standard. It consists of a block based hybrid video coding scheme that exploits temporal and spatial prediction.

High Efficiency Video Coding (HEVC) is a new video coding standard currently being developed in Joint Collaborative Team—Video Coding (JCT-VC). JCT-VC is a collaborative project between MPEG and International Telecommunication Union Telecommunication standardization sector (ITU-T). Currently, a Working Draft (WD) is defined that includes large macroblocks (abbreviated LCUs for Largest Coding Units) and a number of other new tools and is considerably more efficient than H.264/AVC.

At a receiver a decoder receives a bit stream representing pictures, i.e. video data packets of compressed data. The compressed data comprises payload and control information. The control information comprises e.g. information of which reference pictures should be stored in a decoded picture buffer (DPB), also referred to as a reference picture buffer. This information is a relative reference to previous received pictures. Further, the decoder decodes the received bit stream and displays the decoded picture. In addition, the decoded pictures are stored in the decoded picture buffer according to the control information. These stored reference pictures are used by the decoder when decoding subsequent pictures.

A working assumption for the processes of decoded picture buffer operations in the working draft of HEVC is that they will be inherited from H.264/AVC to a very large extent. A simplified flow chart of the scheme as it is designed in H.264/AVC is shown in FIG. 1.

Before the actual decoding of a picture, the frame_num in the slice header is parsed to detect a possible gaps in frame_num if Sequence Parameter Set (SPS) syntax element gaps_in_frame_num_value_allowed_flag is 1. The frame_num indicates the decoding order. If a gap in frame_num is detected, “non-existing” frames are created and inserted into the decoded picture buffer.

Regardless of whether there was a gap in frame_num or not the next step is the actual decoding of the current picture. If the slice headers of the picture contain Memory Management Control Operations (MMCO) commands, adaptive memory control process is applied after decoding of the picture to obtain relative reference to the pictures to be stored in the decoded picture buffer; otherwise a sliding window process is applied to obtain relative reference to the pictures to be stored in the decoded picture buffer. As a final step, the “bumping” process is applied to deliver the pictures in correct order.

A problem with H.264/AVC is its vulnerability to losses of pictures that contains MMCO of type 2, 3, 4, 5 or 6 as described in Table 1 below.

TABLE 1
Memory management control operation values for H.264/AVC

| memory_management_control_operation | Memory Management Control Operation |
|---|---|
| 0 | End memory_management_control_operation syntax |
| | element loop |
| 1 | Mark a short-term reference picture as “unused for |
| | reference” |
| 2 | Mark a long-term reference picture as “unused for |
| | reference” |
| 3 | Mark a short-term reference picture as “used for long- |
| | term reference” and assign a long-term frame index to it |
| 4 | Specify the maximum long-term frame index and mark all |
| | long-term reference pictures having long-term frame |
| | indices greater than the maximum value as “unused for |
| | reference” |
| 5 | Mark all reference pictures as “unused for reference” and |
| | set the MaxLongTermFrameIdx variable to “no long-term |
| | frame indices” |
| 6 | Mark the current picture as “used for long-term |
| | reference” and assign a long-term frame index to it |

Loss of a picture that does not contain MMCO, or a picture that contains MMCO of type 0 or 1, is of course severe to the decoding process. Pixel values of the lost picture will not be available and may affect future pictures for a long period of time due to incorrect inter prediction. There is also a risk that reference picture lists for a few pictures following the lost picture will be wrong, for example if the lost picture contained MMCO that marked one short-term reference picture as “unused for reference” that otherwise would have been included in the reference picture list of the following picture. However, the decoding process can generally recover such a loss through usage of constrained intra blocks, intra slices or by other means.

But if a picture containing MMCO of type 2, 3, 4, 5 or 6 is lost there is a risk that the number of long term pictures in the DPB is different from what it would have been if the picture was received, resulting in an “incorrect” sliding window process for all the following pictures. That is, the encoder and decoder will contain a different number of short-term pictures resulting in out-of-sync behavior of the sliding window process. This loss cannot be recovered through usage of constrained intra blocks, intra slices or similar techniques (not even an open Group Of Picture (GOP) Intra picture). The only way to ensure recovery from such a loss is through an Instantaneous Decoder Refresh (IDR) picture or through an MMCO that cancels the effect of the lost MMCO. What makes the situation even worse is that a decoder will not necessarily know that the sliding window process is out-of-sync and thus cannot report the problem to the encoder or request an IDR picture even in applications where a feedback channel is available.

One way to reduce the risk of loosing important MMCO information is to use dec_ref_pic_marking_repetition Supplementary Enhancement Information (SEI) messages. However the encoder will not know if the decoder is capable of making use of dec_ref_pic_marking_repetition SEI messages. Further, there is a risk that the dec_ref_pic_marking_repetition SEI message is also lost.

In H.264/AVC it is possible to use gaps in the parameter frame_num to realize temporal scalability, through setting the previously mentioned syntax element gaps_in_frame_num_allowed_flag to 1. In such a case, “non-existing” frames are inserted when decoding for every missing frame_num to ensure that the status of the DPB is the same as if the pictures were not missing.

The same functionality is present in Scalable Video Coding (SVC). In SVC there is also a possibility to assign different temporal_id to different pictures to describe the temporal layering structure of the encoded video stream. It is stated that a lower layer should be decodable when a higher layer is removed from the encoded video stream, by applying the methods provided by gaps in frame_num.

There is a need for efficient reference picture and buffer management that do not suffer from the shortcomings and limitations of prior art solutions. It is a particular need for efficient reference picture management in connection with missing pictures for layered video.

### SUMMARY

It is a general objective to provide an efficient reference picture signaling and buffer management in connection with video encoding and decoding.

This and other objectives are met by embodiments disclosed herein.

An aspect of the embodiments relates to a method of decoding an encoded representation of a picture of a video stream of multiple pictures. The method comprises retrieving buffer description information defining at least one reference picture from the encoded representation of the picture. A picture identifier identifying a reference picture of the at least one reference picture as decoding reference for the picture and/or a subsequent picture of the video stream is determined based on the buffer description information. The determined picture identifier is compared to any picture identifier of reference pictures stored in a decoded picture buffer. If the determined picture identifier is not equal to any of the picture identifiers of the stored reference pictures the reference picture is determined as missing. In such a case, a layer identifier of the picture is compared to a layer identifier, retrieved based on the buffer description information, of the reference picture identified by the determined picture identifier. The method then performs at least one of i) determining the reference picture to be unintentionally lost if the layer identifier of the reference picture indicates a lower layer or an equal layer than the layer identifier of the picture and ii) determining the reference picture to be intentionally removed from the video stream if the layer identifier of the reference picture indicates a higher layer than the layer identifier of the picture.

A related aspect of the embodiments defines a decoder configured to decode an encoded representation of a picture of a video stream of multiple pictures. The decoder comprises a data retriever configured to retrieve buffer description information defining at least one reference picture from the encoded representation of the picture. A picture identifier determiner is configured to determine a picture identifier identifying a reference picture of the at least one reference picture as decoding reference for the picture and/or a subsequent picture of the video stream based on the buffer description information. The decoder also comprises a picture determiner configured to determine the reference picture as missing if the picture identifier is not equal to any picture identifier of reference pictures stored in a decoded picture buffer. If the reference picture is determined as missing a layer identifier comparator is configured to compare a layer identifier of the picture with a layer identifier, retrieved based on the buffer description information, of the reference picture. A generator controller is configured to perform at least one of i) determine the reference picture as unintentionally lost if the layer identifier of the reference picture indicates a lower layer or an equal layer than the layer identifier of the picture and ii) determine the reference picture as intentionally removed from the video stream if the layer identifier of the reference picture indicates a higher layer than the layer identifier of the picture.

Another related aspect of the embodiments defines a decoder comprising an input section configured to receive encoded representations of multiple pictures of a video stream. The decoder also comprises a processor configured to process code means of a computer program stored in a memory. The code means causes, when run on the processor, the processor to retrieve buffer description information defining at least one reference picture from the encoded representation of the picture. The processor is also caused to determine a picture identifier identifying a reference picture of the at least one reference picture as decoding reference for the picture and/or a subsequent picture of the video stream. The processor is further caused to determine the reference picture as missing if the picture identifier is not equal to any picture identifier of reference pictures stored in a decoded picture buffer. If the reference picture is determined as missing the processor is caused to compare a layer identifier of the picture with a layer identifier, retrieved based on the buffer description information, of the reference picture. The processor is further caused to perform at least one of i) determine the reference picture as unintentionally lost if the layer identifier of the reference picture indicates a lower layer or an equal layer than the layer identifier of the picture and ii) determine the reference picture as intentionally removed if the layer identifier of the reference picture indicates a higher layer than the layer identifier of the picture. An output section of the decoder is configured to output decoded pictures of the video stream.

Another aspect of the embodiments relates to a method of processing a video stream comprising encoded representations of pictures. The method comprises retrieving a picture identifier and layer identifier from an encoded representation of a picture. Buffer description information defining at least one reference picture is also retrieved from the encoded representation of the picture. A picture identifier identifying a reference picture of the at least one reference picture as decoding reference for the picture and/or a subsequent picture of the video stream is determined based on the buffer description information. The picture identifier of the reference picture is compared to picture identifiers retrieved from previously forwarded encoded representations of pictures in the video stream. If the picture identifier of the reference picture is not equal to any of the picture identifiers retrieved from the previously forwarded encoded representations the layer identifier of the reference picture, obtained based on the buffer description information, is compared to the layer identifier of the picture. If the layer identifier of the reference picture indicates a lower layer or an equal layer than the layer identifier of the picture the encoded representation of the picture is removed from the video stream.

A related aspect of the embodiments defines a network node configured to process a video stream comprising encoded representations of pictures. The network node comprises a data retriever configured to retrieve a picture identifier, a layer identifier and buffer description information from an encoded representation of a picture. The buffer description information is used by a picture identifier determiner to determine a picture identifier identifying a reference picture as decoding reference for the picture and/or a subsequent picture of the video stream. A picture identifier comparator is configured to compare the picture identifier determined by the picture identifier determiner with picture identifiers retrieved from previously forwarded encoded representations of pictures in the video stream. If the picture identifier determined by the picture identifier determiner is not equal to any of the picture identifiers retrieved from previously forwarded encoded representations a layer identifier comparator compares a layer identifier retrieved by the data retriever with a layer identifier of the reference picture obtained based on the buffer description information. The network node comprises a data remover that is configured to remove the encoded representation of the picture from the video stream if the layer identifier of the reference picture indicates a lower layer or an equal layer than the layer identifier retrieved by the data retriever.

In clear contrast to the prior art solutions in which correct reference picture management is dependent on that previously encoded pictures have been correctly received and decoded, the embodiments provide buffer description information that is used for reference pictures in an absolute and explicit way instead of a relative or implicit way. Thus, the encoded representation of a picture contains the information about which reference pictures to use for reference during decoding independent of the encoded representations of previous pictures in the video stream.

The complexity of the decoder is also be reduced by relaxing the need for creating and handling non-existing reference frames each time a missing reference picture is detected.

### BRIEF DESCRIPTION OF THE DRAWINGS

The invention, together with further objects and advantages thereof, may best be understood by making reference to the following description taken together with the accompanying drawings, in which:

FIG. 1 is a simplified flow chart of the H.264/AVC reference buffer scheme;

FIG. 2 is an example of a coding structure with five B pictures in temporal layer 1-2;

FIG. 3 is a flow chart of a method of decoding an encoded representation of a picture according to an embodiment;

FIG. 4 is a video stream of multiple pictures according to an embodiment;

FIG. 5 is an encoded representation of a picture according to an embodiment;

FIG. 6 is a flow chart of an additional, optional step of the method in FIG. 3;

FIG. 7 is a flow chart of an embodiment of generating non-existing picture in FIG. 3;

FIG. 8 is a flow chart of an additional, optional step of the method in FIG. 3;

FIG. 9 is a simplified flow chart of a reference buffer scheme according to an embodiment;

FIG. 10 is a schematic block diagram of a receiver according to an embodiment;

FIG. 11 is a schematic block diagram of a decoder according to an embodiment;

FIG. 12 is a schematic block diagram of a decoder according to another embodiment;

FIG. 13 is a flow chart of a method of processing a video stream according to an embodiment;

FIG. 14 is a schematic block diagram of a transmitter, a network node and a receiver; and

FIG. 15 is a schematic block diagram of a network node according to an embodiment.

### DETAILED DESCRIPTION

Throughout the drawings, the same reference numbers are used for similar or corresponding elements.

The present embodiments generally relate to encoding and decoding of pictures, also referred to as frames in the art, of a video stream. In particular, the embodiments relate to reference picture management for layered video.

Video encoding, such as represented by H.264/MPEG-4 AVC and HEVC, utilizes reference pictures as predictions or references for the encoding and decoding of pixel data of a current picture. This is generally referred to as inter coding in the art where a picture is encoded and decoded relative to such reference pictures. In order to be able to decode an encoded picture, the decoder thereby has to know which reference pictures to use for the current encoded picture and has to have access to these reference pictures. Generally, the decoder uses a decoded picture buffer (DPB), also denoted reference picture buffer herein, for storing the reference pictures. It is then important that the reference pictures stored in the decoded picture buffer are indeed the correct reference pictures when decoding an encoded picture otherwise the decoder will use wrong reference pictures during the decoding process causing a degradation of the quality of the presented video.

The prior art techniques may suffer from problems with regard to using incorrect reference pictures when a picture carrying MMCO information is unintentionally lost, which was discussed in the background section. This problem of the prior art can be illustrated by the following H.264-implemented example. Assume that the decoded picture buffer stores three short term pictures with picture identifiers 300, 302 and 303 and two long term pictures with picture identifiers 0 and 3. The encoder might then generate a new encoded picture with a MMCO type 2 command stating that the long term picture 0 should be unused for reference. If this encoded picture would have been correctly received at the decoder the long term picture 0 would have been marked as unused for reference and the reference picture list would have been {300, 302, 303, 3}. However, if the encoded picture with the MMCO type 2 command is lost, the decoder is not informed that the long term picture 0 should be 30 marked as unused for reference and the reference picture list is therefore instead {300, 302, 303, 0, 3}. If a next encoded picture received at the decoder comprises information that reference picture at position 3 in the reference picture list is to be used as prediction for a macroblock in the picture there will be a problem if the MMCO type 2 command is lost. If the MMCO type 2 command had been correctly received at the decoder, the reference picture at position 3 in the reference picture list would correspond to the long term picture 3 as this reference picture occupies position 3 (if starting with 0) in the reference picture list. However, with a lost MMCO type 2 command position 3 in the reference picture list is instead occupied by the long term picture 0. This means that pixel data from the long term picture 0 will be used as prediction basis instead of the correct pixel data from the long term picture identifier 3.

Thus, the prior art solution has a problem that correct reference picture management is dependant on that previously decoded pictures have been correctly received and decoded.

The present embodiments do not have these problems of the prior art techniques by using a fundamentally different approach for signaling reference pictures as compared to the prior art. The present embodiments instead specify which decoded pictures to be used for reference pictures in an absolute or explicit way instead of a relative or implicit way. Another way to put it is that the encoded representation, i.e. the bitstream, for a current picture contains the information about what pictures to use for reference, i.e. reference pictures, independent of the encoded representations of previous pictures. It can therefore be said that the logical responsibility for maintaining correct decoded picture buffer is moved from the decoder to the bitstream. One way to look at it is to say that the information about what reference pictures to use for inter prediction and motion vector prediction for a picture is included in the control information of the picture. Hence, the state of the decoded picture buffer is signaled for every picture that is encoded and decoded relative to other pictures.

The present embodiments are directed towards so-called layered video, in which pictures or frames of a video stream can be organized into multiple, i.e. at least two, different layers. For instance a temporal layering structure can be used to organize pictures in different temporal layers. Such a structure enables temporal scalability by merely decoding pictures in the lowest temporal layer or the pictures of a subset of the lowest temporal layers up to decoding pictures in all temporal layers.

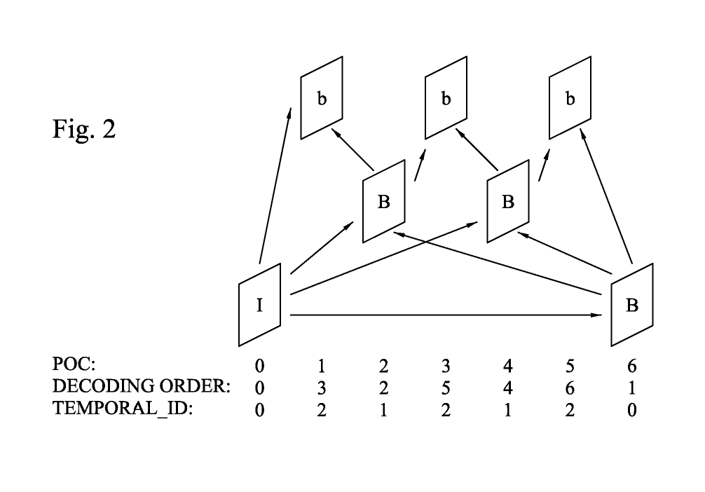

FIG. 2 illustrates an example of a coding structure using temporal scalability. In FIG. 2 the pictures are organized into three different temporal layers. POC denotes Picture Order Count and represents an output order of the pictures in the video stream. The arrows indicate the encoding and decoding relationship of the pictures. For instance, the picture with POC=2 is encoded and decoded according to an inter mode with regard to the picture with POC=0 and the picture with POC=6 as reference pictures. In FIG. 2 each picture is not only associated with a POC value as picture identifier but also a layer identifier, temporalid, indicating which temporal layer a picture belongs to.

Temporal scalability is merely an example of multi-layer video to which the embodiments can be applied. Other types include multi-layer video where each picture has a picture identifier and a view identifier. Further examples of scalability include spatial scalability, signal-to-noise ratio (SNR) scalability, bit-depth scalability and chroma format scalability.

In the prior art “non-existing” pictures are created each time the decoder detects a missing picture. However creation and handling of such “non-existing” pictures has the disadvantages that the decoder has to allocate memory for them and that they add extra decoding complexity for the decoder. Additionally, the usage of non-existing pictures in a video codec adds implementation complexity for hardware and software implementations.

The embodiments combine the concept of absolute reference picture signaling with the restriction that the removal of encoded pictures is limited to temporal scalability and other types of multi-layer video and inferring a normative action in the decoder based on detection of missing pictures in order to avoid creation and usage of “non-existing” pictures.

Hence, the embodiments enable the decoder to determine whether a missing picture is intentionally removed by the encoder or some other unit or network node or whether a missing picture is unintentionally lost in the transmission from the encoder towards the decoder.

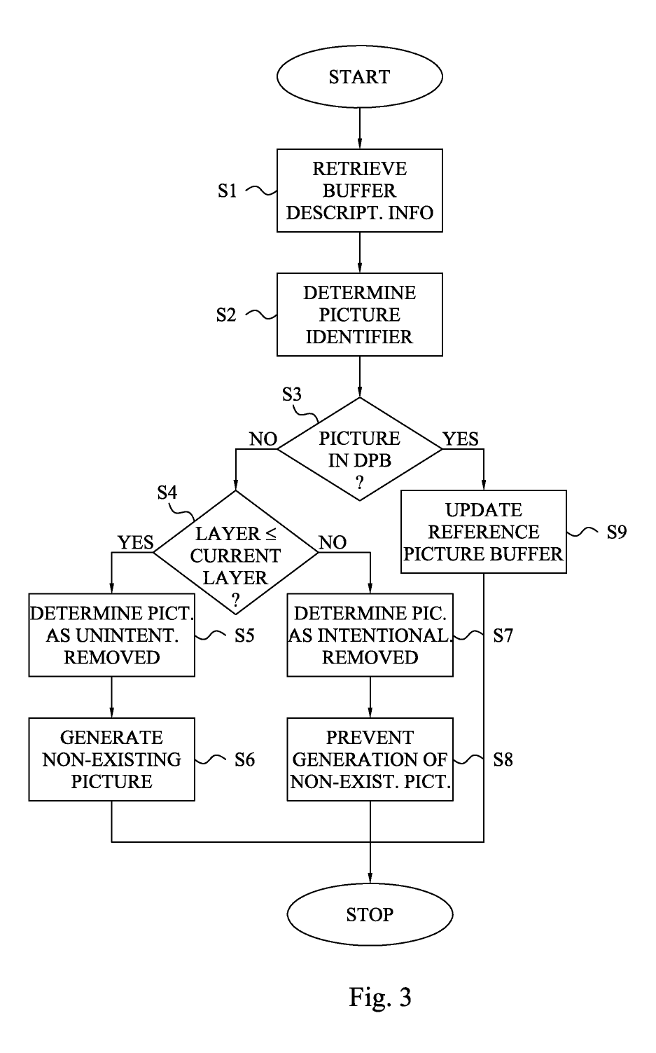

FIG. 3 is a flow chart illustrating a method of decoding an encoded representation of a picture of a video stream according to an embodiment. The method generally starts in step S1 where buffer description information defining at least one reference picture is retrieved from the encoded representation of the picture.

The buffer description information could be provided in any defined portion of the encoded representation of the picture but is typically provided in a control information field in the encoded representation of the picture. The retrieval of the buffer description information can therefore be performed in connection with decoding the control information of the encoded representation of the picture and therefore preferably prior to decoding of the actual payload data of the encoded representation.

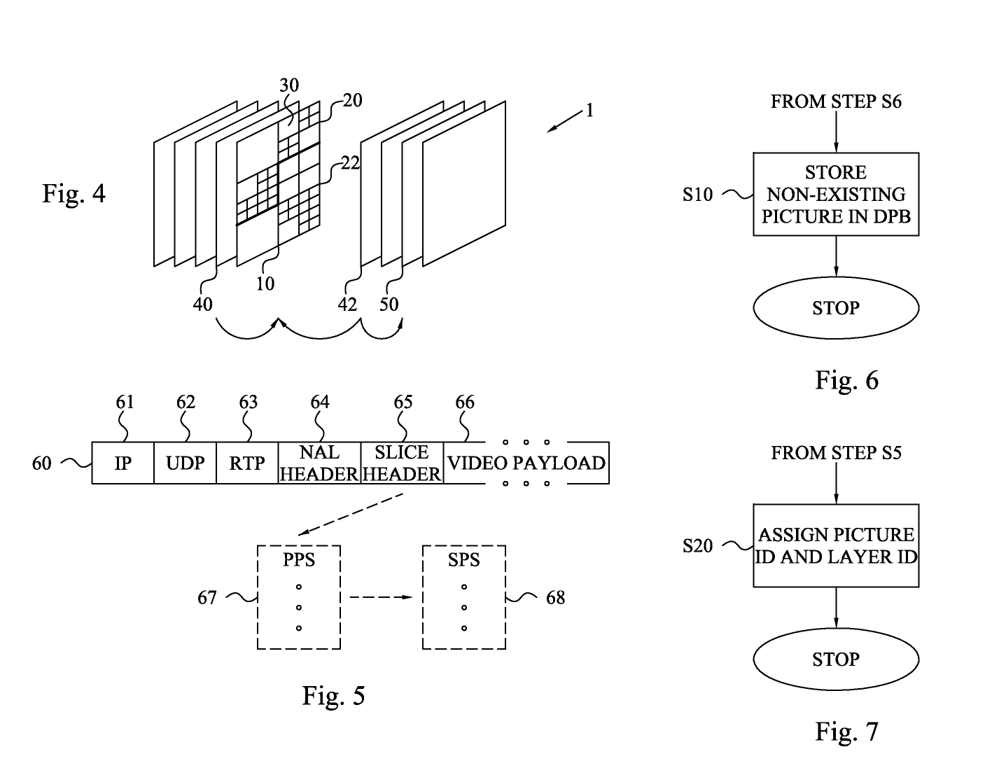

FIG. 5 schematically illustrates an example of an encoded representation 60 of a picture. The encoded representation 60 comprises video payload data 66 that represents the encoded pixel data of the pixel blocks in a slice. The encoded representation 60 also comprises a slice header 65 carrying control information. The slice header 65 forms together with the video payload and a Network Abstraction Layer (NAL) header 64 a NAL unit that is the entity that is output from an encoder. To this NAL unit additional headers, such as Real-time Transport Protocol (RTP) header 63, User Datagram Protocol (UDP) header 62 and Internet Protocol (IP) header 61, can be added to form a data packet that can be transmitted from an encoder to a decoder. This form of packetization of NAL units merely constitute an example in connection with vide transport. Other approaches of handling NAL units, such as file format, MPEG-2 transport streams, MPEG-2 program streams, etc. are possible.

The buffer description information could then be included in the slice header 65, another picture header or another data structure specified by the standard to which the encoder and decoder conforms.

The buffer description information retrieved in step S1 identifies a buffer description, also referred to as reference picture set (RPS), which defines at least one reference picture through a respective picture identifier and a respective layer identifier. Hence, the buffer description defines reference pictures that are used as decoding reference for the current picture to be decoded. This means that the pixel data of the current picture is decoded with reference to one or more reference pictures. Alternatively, or in addition, at least one reference picture defined by the buffer description could be used as decoding reference for a subsequent, according to a decoding order, picture of the video stream, i.e. a picture to be decoded after the current picture. Thus, the buffer description defines all reference pictures that are prior to the current picture in decoding order and that may be used for inter prediction for the current picture or any picture, referred to as subsequent picture herein, following the current picture according to the decoding order.

The buffer description can therefore be regarded as a set of reference pictures associated with a current picture. It consists of all reference pictures that are prior to the current picture in decoding order and that may be used for inter prediction of the current picture or any picture following the current picture in decoding order.

FIG. 4 schematically illustrates this concept by showing a video stream 1 of multiple pictures 10, 40, 42, 50. A current picture 10 may comprise one or more slices 20, 22 comprising pixel blocks 30, such as macroblocks, also referred to as treeblocks, or coding units, to be decoded. The arrows below the pictures 10, 40, 42, 50 indicate the decoding relationship. The current picture 10 is decoded in relation to a previous reference picture 40 and a subsequent reference picture 42. The preceding reference picture 40 is preceding and the subsequent reference picture 42 is subsequent with regard to the current picture 10 according to the output order but both are preceding the current picture 10 according to the decoding order. This subsequent reference picture 42 is furthermore used as reference picture for a subsequent, according to the decoding order, picture 50 in the video stream 1.

The buffer description information retrieved in step S1 of FIG. 3 is used in step S2 to determine a picture identifier that, preferably unambiguously, identifies a reference picture as decoding reference for the picture and/or for a subsequent, with regard to the decoding order, picture of the video stream.

A following step S3 investigates whether the reference picture identified by the picture identifier determined in step S2 is missing or not. This step S3 is performed by comparing the picture identifier with picture identifiers of reference pictures stored in a decoded picture buffer of the decoder. If a reference picture stored in the decoded picture buffer has a picture identifier that is equal to the picture identifier determined in step S2 the method continues to step S9 where the decoded picture buffer is updated based on the determined picture identifier. Updating of the decoded picture buffer will be further described below.

If, however, the picture identifier is not equal to any picture identifier of reference pictures stored in the decoded picture buffer step S3 determines the reference picture identified by the determined picture identifier as missing and the method continues to step S4.

Step S4 verifies whether the missing picture has intentionally been removed or is indeed unintentionally missing, for instance, due to that a data packet carrying at least a portion of the video data of the missing picture has become lost in the transmission from the encoder to the decoder or is received at the decoder but in a state that is not decodable.

In an embodiment step S4 compares a layer identifier of the current picture to be decoded with a layer identifier, retrieved based on said buffer description information, of the reference picture identified by the determined picture identifier. If the layer identifier of the reference picture indicates a higher layer than the layer identifier of the current picture the method continues to step S6 where the reference picture is determined as intentionally removed from the video stream.

Thus, in this case the missing picture should in fact be missing since it belongs to a higher layer of pictures than the current picture and this higher layer should currently not be decoded by the decoder.

The decoder is thereby in step S8 prevented from generating any non-existing or concealed reference picture in the decoded picture buffer. This means that the decoder does not need to generate and handle a non-existing picture in this case as verified by the comparison of layer identifiers in step S4. The processing complexity and the memory usage at the decoder is thereby reduced as compared to if the decoder would always have generated a non-existing picture upon the detection of a missing picture in the encoded video stream.

If step S4 instead determines that the layer identifier of the reference picture indicates a lower layer or an equal layer than the layer identifier of the current picture the method preferably continues to step S5 where the reference picture is determined as unintentionally removed or lost from the video stream. Thus, the data packet carrying the video payload data of reference picture or a portion thereof might have been lost in the transmission in a network or the transmission is interfered so that the decoder cannot correctly decode the data packet.

In an optional embodiment the decoder then compensates for the unintentionally missing picture in step S6 by taking a combating action. For instance, the decoder can generate a so-called concealed or non-existing picture in step S6 to compensate for the unintentionally missing reference picture.

Other embodiments of step S6 are possible than generating a non-existing picture if the reference picture is determined in step S5 to be unintentionally removed or lost. For instance, the decoder can be configured to invoke a concealment process if the layer identifier of the reference picture indicates a lower layer or an equal layer than the layer identifier of the current picture. Such concealment processes are known in the art and for instance disclosed in Joint Video Team (JVT) of ISO/IEC MPEG & ITU-T VCEG (ISO/IEC JTC1/SC29/WG11 and ITU-T SG16 Q.6), document JVT-B042, titled Enhanced Concept of GOP by Miska M. Hannuksela, Jan. 23, 2002.

Another embodiment of step S6 is to generate an error report with a picture identifier of the reference picture determined in step S5 to be unintentionally lost. The error report is then preferably transmitted by the decoder back to the encoder, which can respond thereto by retransmitting the reference picture identified by the error report.

The procedure disclosed above and involving steps S2 and S3 is preferably performed for each picture identifier defined by the retrieved buffer description information. The following action, i.e. performing step S9; steps S4, S7 and S8; or steps S4, S5 and S6, depends on whether the reference picture identified by the determined picture identifier is present in the decoded picture buffer or not and based on the layer identifiers of the reference picture and the current picture.

The updating of the decoded picture buffer in step S9 preferably implies that the reference picture identified by the determined picture identifier is marked as “used for reference” or marked as “used for prediction” to indicate that this reference pictures is to be used as decoding reference or prediction for the current picture and/or any subsequent picture. In a particular embodiment, reference pictures could be marked as used for short-term reference or as used for long-term reference.

It could be possible that the decoded picture buffer comprises reference pictures that are not defined by the buffer description information of the current picture and therefore have picture identifiers that differ from the picture identifiers determined in step S2. In an embodiment, pictures that are available in the decoded picture buffer but not defined based on the buffer description information are marked as “unused for reference” or “unused for prediction” or are removed by the decoder from the decoded picture buffer. Thus, in this embodiment marking of pictures as “unused for reference” or removing reference pictures from the decoded picture buffer is performed by the decoder as a part of updating the decoded picture buffer and therefore prior to decoding the video payload of the current picture.

In an additional embodiment, zero or more of the pictures that are marked as unused for reference by the decoder according to the buffer description are output for display by the decoder. One such example process for output is the bumping process from H.264/MPEG-4 AVC. Output refers herein to output for display. What pictures to use as reference pictures and what pictures to output, i.e. display, is separated in H.264 and HEVC. This means that a picture can be output before it is removed as reference picture, i.e. marked as unused for reference, or it can be removed as reference frame by marking it as unused for reference before it is output.

In a particular embodiment, the buffer description information retrieved from the encoded representation of the picture in step S1 is in fact the buffer description itself. Thus, the buffer description information then comprises a listing of the picture identifier(s) and layer identifier(s) of the reference picture(s) or data allowing calculation of the picture identifier(s) and the layer identifier(s). This latter case will be further described below.

For instance, the buffer description could define a list with picture identifiers 3, 5 and 6 as the reference pictures for a current picture and/or a subsequent picture. The buffer description information retrieved from the encoded representation in step S1 would then include these picture identifiers 3, 5 and 6 in addition to the layer identifiers for these reference pictures.

An alternative approach that is generally more bit efficient, i.e. generally requires fewer number of bits or symbols for defining the picture identifiers, is to signal the reference picture properties, i.e. picture identifiers and optionally the layer identifiers, relative to the value of these properties as signaled for the current picture. For instance, if the current picture has a picture identifier 7 the list of reference pictures with identifiers 3, 5 and 6 could be defined as −1, −2 and −4, which typically can be represented by fewer bits as compared to 3, 5 and 6, in particular if variable length coding is employed for the picture identifiers.

An embodiment of step S2 therefore retrieves a delta identifier based on the buffer description information. The delta identifier is used in step S2 together with a picture identifier of the current picture to calculate the picture identifier of the reference picture.

Thus, in this embodiment information available for the current picture is used by the decoder to construct the final buffer description for the current picture from the signaled buffer description information. Such information includes, but is not limited to, current POC (POC(curr)), which together with a signaled deltaPOC can be used to calculate the POC of the reference picture (POC(ret)) as POC(ret)=POC(curr)+deltaPOC. In such a case, the delta identifier deltaPOC is advantageously encoded with a variable length code.

The layer identifiers of the reference pictures defined by the buffer description information could be encoded explicitly either in variable length code or fixed length code or could be encoded relative to the layer identifier of the current picture, such as in variable length code, similar to the picture identifiers (layer_id(ret)=layer_id(curr)−deltalayer_id). In the above embodiments providing an explicit signaling of the picture identifiers and layer identifiers, either the picture identifiers and the layer identifiers themselves or the delta identifiers, the buffer description information will in fact constitute the buffer description of the current picture. This buffer description information is present in the encoded representation of the picture, such as in a slice header or other control information field of the encoded representation of the picture.

In another embodiment the buffer description information present in the encoded representation of the picture does not necessarily have to be the same as the buffer description of the current picture but rather enables identification and retrieval of the buffer description. Thus, in this embodiment the buffer description information present in the encoded representation of the picture indirectly defines the reference pictures by pointing towards the buffer description which carries the picture identifiers and layer identifiers, or the delta identifiers enabling calculation of the picture identifiers and/or the layer identifiers of the reference pictures.

In such a case, the buffer description could be carried by a data structure associated to the encoded representation 60 of the picture, see FIG. 5. Examples of such data structures include a Picture Parameter Set (PPS) 67 and a Sequence Parameter Set (SPS) 68. The PPS 67 and/or the SPS 68 could be directly included in the encoded representation 60 but is typically associated thereto through the inclusion of a PPS identifier and/or SPS identifier in the encoded representation 60. For instance, each slice header 65 could include a PPS identifier notifying which PPS 67 to apply for the current picture. The relevant PPS 67 may in turn include an SPS identifier notifying which SPS 68 to apply for the PPS 67 and therefore for the current picture.

The buffer description could then be inserted in the PPS 67 or the SPS 68 assigned to the current picture. In such a case, the PPS identifier or SPS identifier that is present in the encoded representation 60 constitutes the buffer description information that is present in the encoded representation 60. This PPS identifier or SPS identifier then enables retrieval of the buffer description that defines the reference pictures and the PPS identifier or SPS identifier therefore indirectly defines the reference picture.

PPS 67 and SPS 68 merely constitutes examples of data structures associated to encoded representations 60 of pictures and which can be used to carry buffer description information according to the embodiments.

The PPS and SPS are typically shared between multiple pictures in the video stream. Therefore signaling the buffer description of a picture in the PSS and the SPS is preferably performed by providing a data structure, such as table, comprising multiple predefined buffer descriptions each defining respective reference pictures.

Each buffer description of the generated data structure then defines the reference pictures as disclosed herein in terms of picture identifiers and layer identifiers or the delta identifiers from which the picture identifiers and optionally the layer identifiers can be calculated based on the picture identifier or layer identifier of the current picture. Each buffer description could then be provided as an entry in the data structure or table.

The data structure is signaled from the encoder to the decoder. This signaling can be performed according to various embodiments. The data structure could be carried in the PPS, the SPS, a novel parameter set or in another data structure specified by the standard to which the encoder and decoder conforms. In such a case, the encoded representation of a picture comprises a PPS identifier or an SPS identifier, such in a slice header. This PPS identifier or SPS identifier, constituting part of the buffer description information, enables identification of the data structure that is available when decoding the current picture.

In order to specify which buffer description of the data structure to use for the current picture an identifier, constituting part of the buffer description information, is signaled for the current picture and included in the encoded representation of the picture. An example of such an identifier is a non-negative integer signaled in the slice header(s) of the current picture representing the number of the buffer description in the order in which the buffer descriptions appear in the data structure

Introducing buffer description entries in, for instance, the SPS reduces the bit overhead of signaling the buffer descriptions explicitly in the slice header. These buffer descriptions can be used for multiple slices/pictures in the same sequence, i.e. video stream, and thus reduce the number of bits required per picture.

According to a further embodiment, explicit signaling of buffer description and reference signaling to an entry in a general data structure with multiple predefined buffer descriptions, such as an entry in the table above, can be combined. In such a case, these can be combined by the decoder to form a final buffer description for the current picture. One way to combine the explicit signaling and the reference signaling is to join the set of reference pictures described by explicit signaling with the set of reference pictures described by the reference signaling to form a joint set of reference pictures.

In a particular embodiment, the encoded representation of the picture preferably comprises a flag to indicate whether explicit signaling of the buffer description information and/or implicit signaling of the buffer description information has been selected for the current picture. This flag could, for instance, be included in the slice header of the encoded representation of the picture or in some other control information field.

FIG. 6 is a flow chart illustrating an additional optional step of the method in FIG. 3. The method continues from step S6 in FIG. 3. A next step 310 stores the generated non-existing reference picture in the decoded picture buffer. Thus, the non-existing reference picture is thereby made available to the decoder by its inclusion in the decoded picture buffer.

FIG. 7 is a flow chart illustrating an embodiment of step S6 in FIG. 3. The method continues from step S5 in FIG. 3. A next step S20 generates the non-existing reference picture by assigning the picture identifier determined in step S2 and the layer identifier retrieved for the reference picture based on the buffer description information to the non-existing reference picture.

Thus, in an embodiment such a non-existing reference picture is given values to variables holding information that is used by the decoder in the decoding process even if the reference picture is not used for inter prediction or motion vector prediction. Such information could include, but is not limited to, decoding order number (frame_num), display or output order number (POC), temporal layer information (temporal_id), view information (view_id), etc.

The generation of any non-existing picture in step S6 of FIG. 3 is preferably performed prior to decoding the current picture, i.e. decoding the video payload of the current picture.

In an embodiment, the buffer description may contain information that is used by the decoder in reference picture list initialization or reference picture list modification or reference picture list combination. An example is that the order in which the pictures are listed in a buffer description can be used as the initial order for one of the reference picture lists in reference picture list initialization. Hence, the buffer description information can be used when the reference picture list is created.

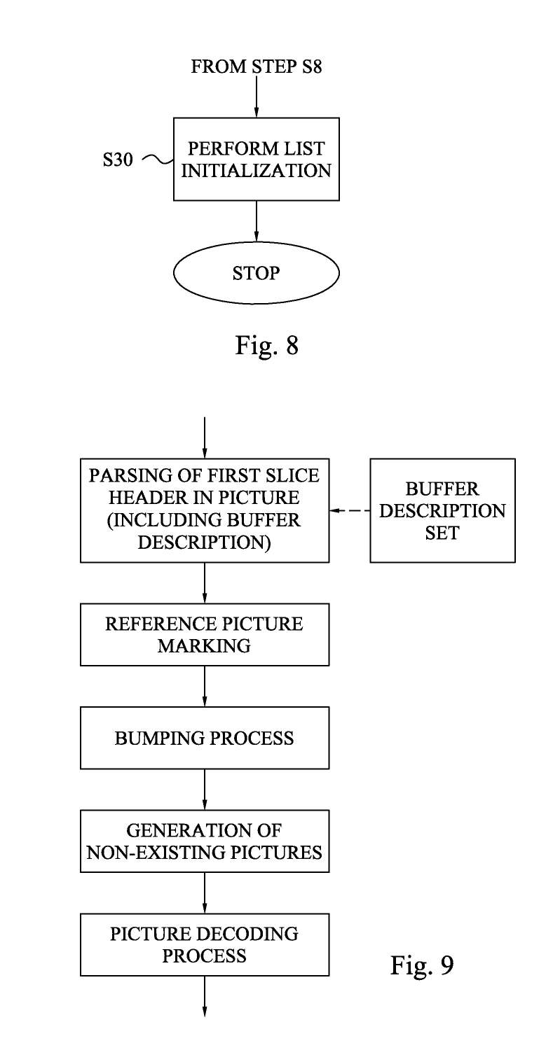

FIG. 8 is a flow chart illustrating such an approach. The method continues from step S8 of FIG. 3 (or indeed from steps S6 or S9 in FIG. 3). A next step S30 performs reference picture list initialization based on the buffer description information. In a particular embodiment of step S30, the reference picture list initialization is performed based on the buffer description information by ordering reference pictures in a reference picture list according to an order that the buffer description information defines the picture identifiers determined in step S2 of FIG. 2.

In a particular embodiment, any reference picture determined in step S7 as intentionally removed from the video stream is excluded from the reference picture list initialization.

In a particular embodiment of the method in FIG. 3, step S4 compares a temporal layer identifier of the current picture with a temporal layer identifier, retrieved based on the buffer description information, of the reference picture identified by the picture identifier determined in step S2. Step S7 determines the reference picture as intentionally removed if the temporal layer identifier of the reference picture is higher than the temporal layer identifier of the current picture. Step S5 correspondingly determines the reference picture as unintentionally removed if the temporal layer identifier of the reference picture is equal to or lower than the temporal layer identifier of the current picture.

There are various alternatives available that could be used as picture identifier according to the embodiments. For instance, the picture identifier could be the decoding order number, the display order number, the output order number or a combination of display order number and an additional identifier or indeed any other information that can be used to unambiguously identify the picture.

Examples of such picture identifiers include Picture Order Count (POC), frame number (frame_num) or POC and an additional identifier (additional_picture_id).

In a particular embodiment, the actual value of the picture identifier is used together with additional information or other data, such as the position of the picture identifier in buffer description information to unambiguously identify the relevant reference picture. Hence, the buffer description identified or obtained by the buffer description information enables an unambiguously identification of the relevant reference picture(s). In an embodiment, the picture identifier itself, such as POC or POC plus an additional identifier, can be used to unambiguously identify the reference picture.

Unambiguously identify a reference picture is used herein to denote that the picture identifier itself or the picture identifier together with other information in the buffer description information, such as the order at which the buffer description information defines the picture identifiers, is used to explicitly identify a reference picture. Hence, given the picture identifier or the picture identifier and the other information enables identification of the relevant reference picture among the pictures of the video stream.

FIG. 9 is a simplified flow chart of a reference buffer scheme according to an embodiment. In this scheme all decoded picture buffer operations are applied after parsing of the first slice header of a picture but before the picture decoding, using a description of the decoded picture buffer as illustrated in FIG. 9. The buffer description is, for instance, signaled in the slice header either explicitly or by reference to a predefined structure signaled in a PPS.

The embodiments thereby provide large conceptual changes to the decoding process. In traditional H.264/MPEG-4 AVC and current design of HEVC, relative operations are given to the decoder either implicitly, i.e. sliding window, or explicitly, MMCO, and the decoder is responsible for applying these relative operations and keeping track of the reference pictures, i.e. which pictures can be used for reference. In the proposed scheme the reference pictures, i.e. which pictures can be used for reference, is signaled within the current picture, such as in the slice header, thus removing the need of implicitly and explicitly signaled relative operations.

This means that each picture will have an absolute description of the reference pictures instead of a relative description as in H.264/MEPG-4 AVC where delta information is retrieved from MMCO or from using the sliding window process.

According to a particular embodiment, the buffer description contains delta_POC, termporal_id and additional_picture_id of all reference pictures in the decoded picture buffer in order to provide an absolute reference to the pictures to be used as reference pictures. The delta_POC is used to calculate the POC of a reference picture as POC(ret)=POC(current)+delta_POC. Pictures will, in an embodiment, be identified by the pair POC and additional_picture_id. Temporal_id is included in the buffer description to enable correct reference picture list modification in the case of lost or removed pictures, e.g. temporal scalability. The scheme is, though, not restricted to the codewords delta_POC, temporal_id and additional_picture_id. Any codeword that is associated with a picture and used in the reference picture handling can be used as picture identifier and may be included in the buffer description, either relative to the value of the current picture, e.g. POC and delta_POC, or absolute, e.g. temporal_id.

All pictures in the decoded picture buffer that are not part of the buffer description are preferably marked as unused for reference.

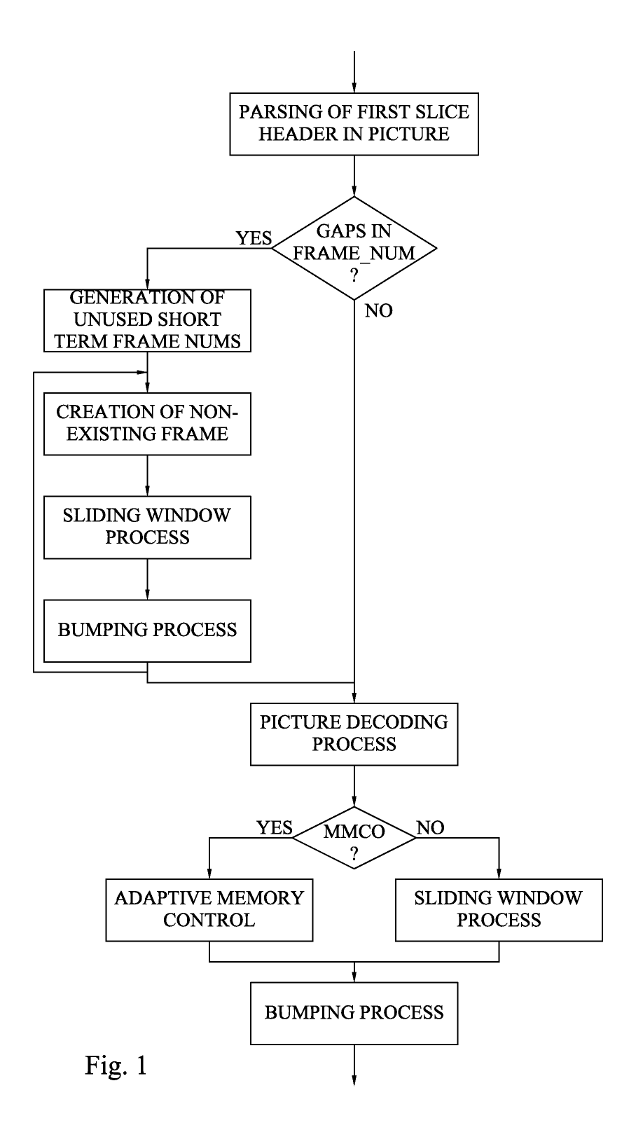

In H.264/MPEG-4 AVC the process that delivers pictures for output (referred to as “bumping” process in FIG. 1) is sometimes performed prior to decoding, i.e. if there was a gap in frame num. The “bumping” process is also performed after decoding and picture marking.

In the proposed scheme of FIG. 9 the “bumping” process is applied prior to decoding. It could be argued that this imposes extra delay in the decoding process before delivery of pictures for output. However it should be noted that the first picture to display is uniquely defined already after the decoding process step as soon as the number of non-displayed pictures in decoded picture buffer is larger than or equal to num_reorder_frames. Thus, a decoder can deliver that picture for display directly after the decoding process step. Thus the delay of the proposed scheme is equal to the delay of the current HEVC scheme.

In H.264/MPEG-4 AVC the syntax element frame_num is used to identify pictures in the decoded picture buffer and to detect gaps in frame_num. If gaps_in_frame_num_allowed is equal to 1 the decoder shall insert “non-existing” frames in the decoded picture buffer in order for the sliding window process to operate correctly.

In the proposed scheme illustrated in FIG. 9 the combination of POC and additional_picture_id can be used to identify pictures in the decoded picture buffer. The proposed scheme does not need to contain a sliding window process. Therefore, it is proposed to remove the syntax elements frame_num and gaps_in_frame_num_allowed.

FIG. 11 is a schematic block diagram of a decoder 100 according to an embodiment. The decoder 100 is configured to decode an encoded representation of a picture of a video stream of multiple pictures. The decoder 100 comprises a data retriever 110 configured to configured to retrieve buffer description information identifying a buffer description defining at least reference picture from the encoded representation of the picture. A picture identifier determiner 120 is configured to determine a picture identifier identifying a reference picture as decoding reference for the current picture and/or for a subsequent picture in the video stream. The picture identifier determiner 120 determines this picture identifier based on the buffer description information retrieved by the data retriever 110 from the encoded representation of the picture. The decoder 100 also comprises a picture determiner 130 configured to determine the reference picture identified by the picture identifier determined by the picture identifier determiner 120 as missing or not. In more detail, the picture determiner 130 determines the reference picture as missing if the picture identifier is not equal to any picture identifier of reference pictures stored in a decoded picture buffer of or associated to the decoder 100. If a reference picture is determined as missing by the picture determiner 130 a layer identifier comparator 140 is configured to compare a layer identifier of the current picture with a layer identifier, retrieved based on the buffer description information, of the reference picture. The decoder 100 also comprises a generator controller 160 configured to perform at least one of determine whether the missing reference picture is intentionally removed or determine whether the missing picture is unintentionally missing from the video stream. The generator controller 160 preferably determines the reference picture as unintentionally removed or missing if the layer identifier of the reference picture indicates a lower layer or an equal layer than the layer identifier of the current picture. The generator controller 160 correspondingly preferably determines the reference picture as intentionally removed if the layer identifier of the reference picture indicates a higher layer than the layer identifier of the current picture.

In an embodiment and if the generator controller 160 determines the missing reference picture as intentionally removed, the generator controller 160 preferably prevents a picture generator 150 of the decoder 100 from generating a non-existing reference picture.

In a particular embodiment the generator controller 160 is preferably configured to control the picture generator 150 to generate a concealed or non-existing picture in the decoded picture buffer if the missing picture is determined to be unintentionally removed. This non-existing reference picture is preferably assigned the picture identifier determined by the picture determiner 130 and the layer identifier retrieved based on the buffer description information by the picture generator controller 150. The picture generator 150 preferably generates any non-existing reference picture as controlled by the generator controller 160 prior to the decoder 100 decoding the video payload data of the picture.

The non-existing reference picture generated by the picture generator 150 is preferably stored in the decoded picture buffer by a buffer manager 170 of the decoder 100.

In an alternative embodiment, the generator controller 160 is configured to control the decoder 100 to invoke a concealment process or generate and transmit an error report as previously disclosed herein.

The buffer manager 170 is preferably also configured to update the decoded picture buffer based on the picture identifier determined by the picture identifier determiner 120, in particular for reference pictures defined by the buffer description information and not determined as missing by the picture determiner 130.

In a preferred approach, the buffer manager 170 is configured to mark all reference pictures stored in the decoded picture buffer but not being associated with any of the picture identifiers from the buffer description as unused for reference. The reference pictures present in decoded picture buffer and associated with any of the picture identifiers from the buffer description are instead preferably marked as used for reference.

The buffer manager 170 of the decoder 100 is preferably configured to mark any reference picture prior to the decoder 100 decoding the current picture.

In a particular embodiment the decoder 100 is configured to output zero or more pictures from the decoded picture buffer for display prior to the decoder 100 decodes the current picture. In a particular embodiment, the decoder 100 outputs any reference picture marked as unused for reference by the buffer manager 170.

Once the buffer manager 170 has updated the decoded picture buffer the decoder 100 can decode the picture, i.e. decode the video payload data, based on the encoded representation of the picture and at least one reference picture stored in the updated decoded picture buffer.

The buffer description information is preferably provided in control information of the encoded representation of the picture. For instance, the data retriever 110 could be configured to retrieve the buffer description information from a slice header of the encoded representation of the picture. In such a case the buffer description information is preferably retrieved from the first slice header received for the current picture since any remaining slice headers of the picture will preferably carry the same buffer description information.

The retrieved buffer description information could include explicit picture identifiers of the reference pictures to be stored in the decoded picture buffer. In an alternative embodiment, the buffer description information defines a respective delta identifier for the reference pictures. The picture identifier determiner 120 is then configured to retrieve the at least one delta identifier from the buffer description information and calculate the at least one picture identifier based on the respective delta identifier and the picture identifier of the current picture, preferably as a sum of the delta identifier and the picture identifier of the current picture. The layer identifiers of the reference pictures can either be explicitly encoded or encoded as delta identifiers.

Instead of explicit signaling of picture identifiers or delta identifiers and layer identifiers in the encoded representation of the picture a reference signaling can be used. The data retriever 110 is in this embodiment configured to retrieve an identifier of a buffer description from the encoded representation of the picture. The data retriever 110 is further configured to identify a buffer description from a data structure comprising multiple predefined buffer descriptions using the retrieved identifier of the buffer description.

The data retriever 110 is preferably in this embodiment also configured to retrieve the data structure defining the multiple predefined buffer descriptions from a control information field of or associated with an encoded representation of the video stream, such as from a PPS or SPS.

In a particular embodiment a control information field of the encoded representation of the picture, such as slice header, preferably comprises an identifier of the control information field, such as PPS or SPS, carrying the data structure. The data retriever 110 thereby retrieves this identifier and uses it to identify the relevant control information field with the data structure.

The decoder 100 may also comprise a list manager 180 configured to perform reference picture list initialization based on the buffer description information. In a particular embodiment, the list manager 180 is configured to perform the reference picture list initialization by ordering reference pictures in a reference picture list according to an order that the buffer description information defines the at least one picture identifier. Hence, the buffer description information not only defines the picture identifiers of the reference pictures but the order at which these are defined in the buffer description information also provides instructions to the list manager 180 with regard to forming the reference picture list. The list manager 180 is preferably configured to exclude any reference pictures determined by the picture determiner 130 as intentionally removed from the reference picture list initialization.

In a particular embodiment, the layer identifier retrieved based on the buffer description information and used by the layer identifier comparator 140 is preferably a temporal layer identifier, temporal_id.

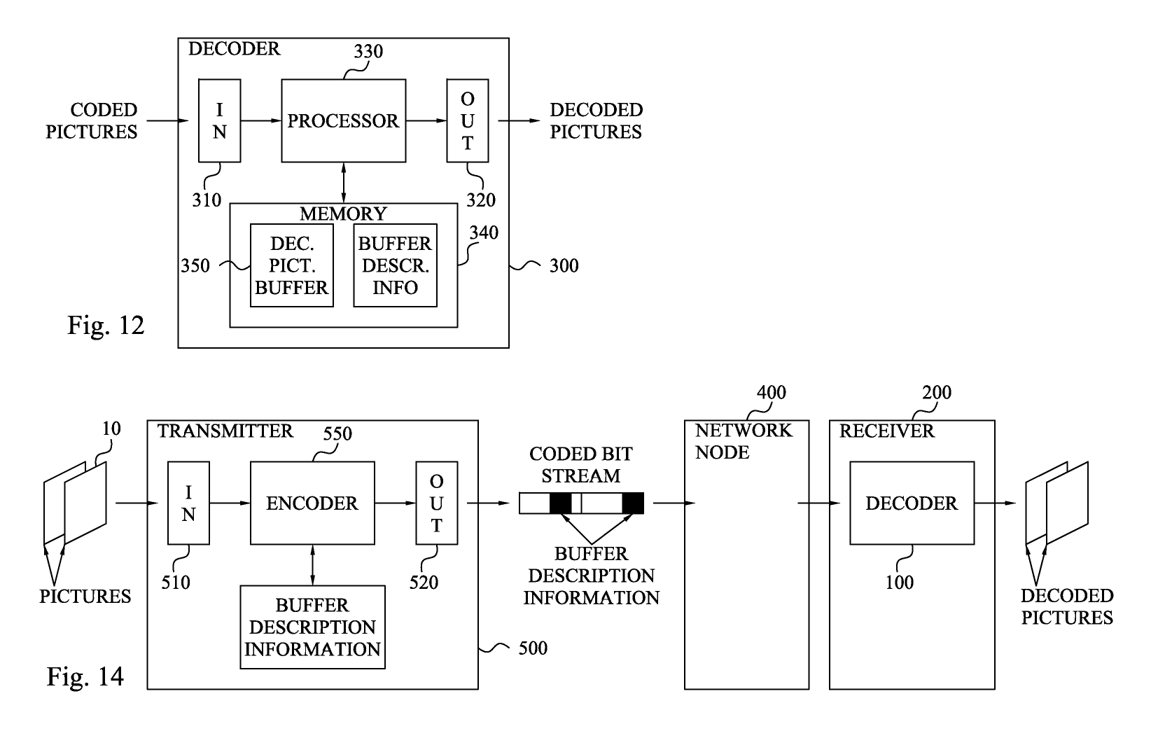

The decoder could be implemented at least partly in software. In such an embodiment as shown in FIG. 12, the decoder 300 comprises an input section 310 configured to receive encoded representations of multiple pictures of a video stream. The decoder 300 also comprises a processor 330 configured to process code means of a computer program stored in a memory 340. The code means causes, when run on the processor 330, the processor 330 to retrieve buffer description information defining at least one reference picture from an encoded representation of a picture. The code means also causes the processor 330 to determine a picture identifier identifying a reference picture of the at least one reference picture based on the buffer description information. The reference picture is to be used as decoding reference for the picture and/or a subsequent picture in the video stream. The processor 330 is further caused to determine the reference picture as missing if the picture identifier is not equal to any picture identifier of reference pictures stored in a decoded picture buffer 350. The processor 330 is also caused to compare, if the reference picture is determined as missing, a layer identifier of the picture with a layer identifier of the reference picture as retrieved based on the buffer description information. The processor 330 then determines the reference picture as intentionally removed from the video stream if the layer identifier of the reference picture indicates a higher layer than the layer identifier of the picture. The decoder 300 also comprises an output section 320 configured to output the decoded pictures of the video stream.

The processor 330 could be a general purpose or specially adapted computer, processor or microprocessor, such as a central processing unit (CPU). The software includes computer program code elements or software code portions effectuating the operation of at least data retriever 110, the picture identifier determiner 120, the picture determiner 130, the layer identifier comparator 140 and the generator controller 160 of FIG. 11.

The program may be stored in whole or part, on or in one or more suitable volatile computer readable media or data storage means, such as RAM, or one or more non-volatile computer readable media or data storage means, such as magnetic disks, CD-ROMs, DVD disks, hard discs, in ROM or flash memory. The data storage means can be a local data storage means or is remotely provided, such as in a data server. The software may thus be loaded into the operating memory of a computer or equivalent processing system for execution by a processor. The computer/processor does not have to be dedicated to only execute the above-described functions but may also execute other software tasks. A non-limiting example of program code used to define the decoder 300 include single instruction multiple data (SIMD) code.

Alternatively the decoder can be implemented in hardware. There are numerous variants of circuitry elements that can be used and combined to achieve the functions of the units 110-180 of the decoder 100 in FIG. 11. Such variants are encompassed by the embodiments. Particular examples of hardware implementation of the decoder 100 is implementation in digital signal processor (DSP) hardware and integrated circuit technology, including both general-purpose electronic circuitry and application-specific circuitry.

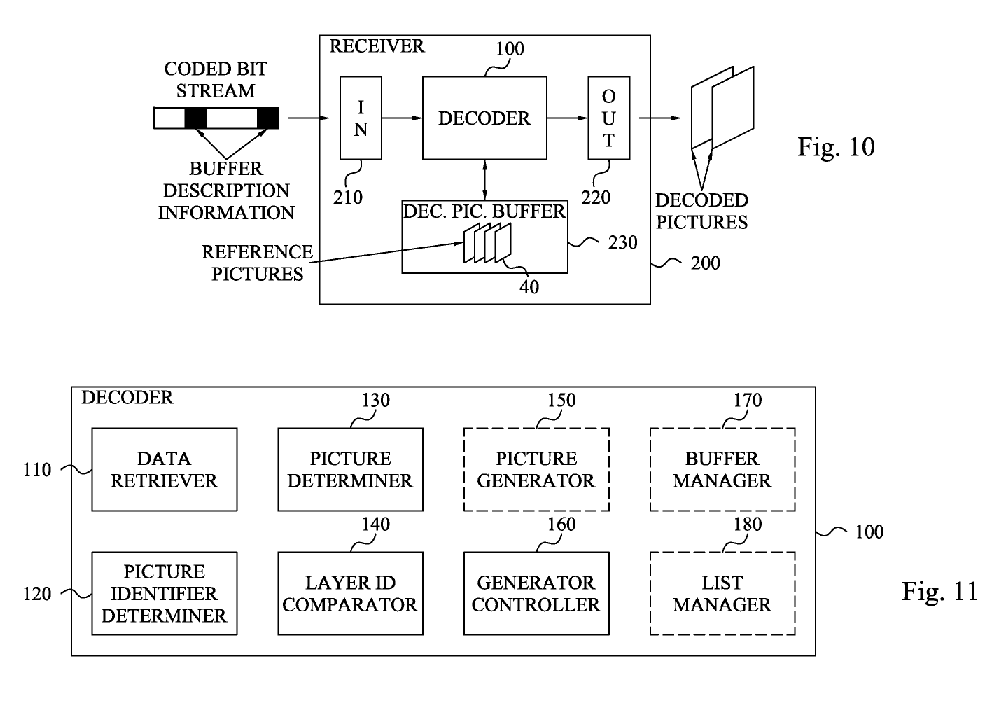

According to an aspect of the embodiments a receiver 200 as shown in FIG. 10 is provided. The receiver 200 comprises an input section 210 configured to receive encoded representations of multiple pictures of a video stream. The encoded representation carries buffer description information according to the embodiments. The encoded representations are forwarded to a decoder 100, such as illustrated in FIG. 11 or in FIG. 12, which is configured to decode the encoded representations of the multiple pictures. An output section 220 of the receiver 200 is configured to output decoded pictures of the video stream. The receiver 200 also comprises a decoded picture buffer 230 storing reference pictures to be used by the decoder 100 when decoding the pictures.

Embodiments are based on the premise that correct information about the reference pictures is available when decoding the current picture or frame regardless of whether the previous pictures or frames are correctly received and decoded or not. One method that fulfills this premise is the absolute reference picture signaling presented above.

As described in the background section, SVC provides two different methods for temporal scalability. The method inherited from H.264/AVC using gaps in frame_num and a method based on temporal_id, which in turn uses gaps in frame_num. The difference is that the SVC method with temporal_id provides signaling to a node in the network what pictures to remove from a bitstream in order to forward a sub-set of the layers in the bitstream.

It has informally been concluded within the research community of video coding that only one method for temporal scalability is needed and that the functionality of general removal of a sub-set of pictures from the same temporal layer (called sub-sequences in H.264/AVC) is an unnecessary feature.

Thus it can be introduced as a rule that removal of pictures may only be done for a layer tId if the pictures that are removed all have a temporal_id that is higher than tId.

The term temporal switching point is used to indicate a point represented by a picture in the bitstream where it is possible for a decoder (or network node) to change the number of temporal layers that it decodes (or forwards).

Restrictions or rules for temporal down-switching are not needed as it is advantageous to specify that down-switching is always possible. This is automatically realized by a rule specifying that a lower temporal layer shall in no way be dependant on higher temporal layers, thus making it irrelevant, in the view of the lower layer, how many pictures of higher layers that have been received and/or decoded.

The only exception to this rule would be a “temporal switching point”, i.e. a point in the coded video stream where a decoder can change path of operation from decoding the x lowest temporal layers to decoding the y lowest temporal layers where y is a higher layer than x.

That is, for any picture A with temporal_id tIdA, represented in the coded video bitstream, the bitstream must contain every picture B with temporal_id tIdB for which tIdB≦tIdA, if B precedes A in decoder order and there is no switching point in-between B and A in decoding order. The switching point may by explicitly signal with normative effect to the decoding process as in current WD of HEVC or without normative effect to the decoding process as in SVC. The switching point may also be inferred without explicit signaling, i.e. by a coding structure that fulfills requirements for temporal switching.

If these rules are applied, or similar limitations or requirements are put on the bitstream the embodiments induce the following actions if a picture that is included in an absolute description of the reference pictures is not present among the pictures available for reference in the decoder, in other words there is a picture missing:

The decoder preferably compares the contents of its decoded picture buffer with the buffer description and labels all pictures in the buffer description that are marked as reference pictures but are not present as reference pictures in the decoded picture buffer as missing. The decoder preferably further compares the temporal_id of the missing picture, denoted tIdM, as provided by the buffer description, with the temporal_id of the current picture, denoted tIdC.

If tIdM is higher than tIdC, the missing picture is inferred to be an “intentionally removed picture”. Even though the picture identifier, such as POC, and temporal_id are available for the missing pictures, these values are preferably not stored, i.e. no “non-existing” picture should be created and the missing picture or frame is preferably excluded from all reference picture list construction processes.

If tIdM is equal to or lower than tIdC the decoding process should infer an unintentional picture loss of the missing picture with temporal_id equal to tIdM.

An encoder or a network node in the network should not encode or forward a bitstream such that any missing picture X have the same or lower temporal_id as an encoded and forwarded picture Y for any Y included in the bitstream that contains X in its buffer description and for which X is labeled missing.

Formulated as a requirement of the bitstream it can be said that a bitstream should not contain a picture A that uses a buffer description, signaled explicitly in the slice header or by reference to a picture parameter set, that includes a picture B with temporal_id lower than or equal to the temporal_id of A unless B is available in the decoded picture buffer and marked as “used for reference” for any decoder decoding the bitstream according to the decoding process of a standard specification of HEVC.

The bitstream in the sentence above being any bitstream conforming to a video codec specification that might have been temporally rescaled by down-switching performed at any point and by up-switching performed at legal up-switching point. “HEVC” can be replaced by any other standard to which the embodiment might be relevant. “Slice header” can be replaced by any other appropriate data structure such as Picture Header or Slice Parameter Set. “Picture Parameter Set” can be replaced by any other appropriate data structure such as Picture Header or Slice Parameter Set or Sequence Parameter Set.

By using an absolute reference picture signaling the decoder is ensured that the status of the decoded picture buffer is the same when decoding one picture regardless of how many temporal layers above the temporal layer of the current picture have been removed.

In an alternative embodiment, the video codec is a multiview video codec and view_id is replacing temporal_id in the description above. Correspondingly, temporal layers are replaced by views and temporal switching is replaced by view switching.

Similarly, the embodiment can be applied to any layered video coding scheme, such as but not limited to spatial scalability, SNR scalability, bit-depth scalability and chroma format scalability, where pictures are associated with layers through syntax elements in a buffer description, the layers being ordered and having the property that a layer is ignorant of pictures belonging to a higher layer.

The embodiments reduce complexity in the decoder since missing pictures are excluded from all reference picture list construction processes and no “no-existing” frames need to be created. The embodiments also enable a unified and clear concept for temporal scalability and reduce the amount of logic enforced at the encoder for various coding structures.

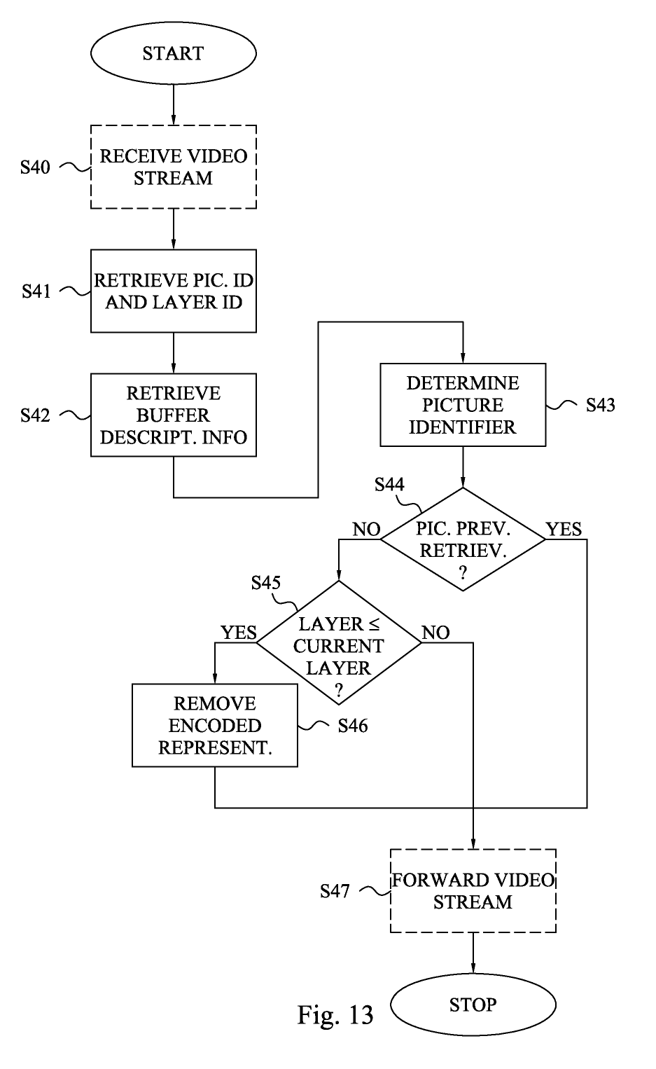

FIG. 13 is a flow chart of a method of processing a video stream comprising encoded representation of pictures. The method starts in an optional step S40 where the video stream is received. Hence, encoded representations of pictures in the video stream are received and are to be processed further as disclosed herebelow. This processing of the video stream can be performed by any device, node or unit present in the communication path from an encoder encoding the pictures of the video stream to a decoder decoding the encoded representations of the pictures. The device, node or unit could, for instance, be implemented in a network, either a wired or wireless network, used to transmit the video stream to the decoder. The processing could for instance be conducted in a network node represented by a base station, NodeB or base transceiver station or some other entity of the network. FIG. 14 schematically illustrates this concept.

FIG. 14 a transmitter 500 comprising an input section 510 configured to receive pictures 10 to be encoded by an encoder 550. The encoder 550 generates respective encoded representations of the pictures, where such encoded representations could comprise the buffer description information disclosed herein. The encoded representations of the pictures are forwarded to an output section 520 configured to transmit a coded bit stream of the encoded representation towards a receiver 200 comprising a decoder 100. A network node 400 could then be present in the wired or wireless network between the transmitter 500 and the receiver 200.

A next step S41 retrieves a picture identifier and a layer identifier from an encoded representation of a picture in the video stream. These identifiers are preferably retrieved from the slice header of the encoded representation or from some other defined control information field. Hence, the retrieval of the identifiers in step S41 is preferably performed without the need to decode the complete encoded representation of the picture and in particular without the need to decode the video payload data.

Step S42 retrieves buffer description information defining at least one reference picture from the encoded representation of the picture. This step S42 corresponds to step S1 in FIG. 3 and is not further described herein.

Steps S41 and S42 can be performed serially in any order or at least partly in parallel.

A next step S43 determines a picture identifier identifying a reference picture as decoding reference for the picture and/or for a subsequent, according to the decoding order, picture of the video stream based on the buffer description information retrieved in step S42. This step S43 basically corresponds to step S2 in FIG. 3.

Step S44 compares the picture identifier determined in step S43 with picture identifiers retrieved from previously received and forwarded encoded representations of pictures in the video stream. Hence, once an encoded representation of a picture is received in step S40 and its picture identifier is retrieved in step S41 this picture identifier is stored if the encoded representation of the picture is forwarded in step S47. Thus, the device, node or unit preferably keeps a record or list of the picture identifiers of the encoded representations it has forwarded towards the decoder.

If the picture identifier is equal to any of the picture identifiers retrieved from previously forwarded encoded representations the method continues to step S47 and the current encoded representation is forwarded towards to the decoder. The picture identifier retrieved in step S41 is also entered in the above mentioned record or list.

If the picture identifier determined in step S43 is not equal to any of the picture identifiers retrieved from previously forwarded encoded representations of pictures in the video stream the method continues from step S44 to step S45. Step S45 compares a layer identifier of the reference picture obtained based on the retrieved buffer description information with the layer identifier of the picture as retrieved in step S41.

If the layer identifier of the reference picture indicates a lower layer or an equal layer than the layer identifier of the picture the method continues to step S46 where the current encoded representation of the picture is removed from the video stream. The reason for this removal is that the device, node or unit should not forward any bitstream such that a missing picture has the same or lower layer identifier as an encoded picture included in the bitstream and defining the missing picture as reference picture in its buffer description information.

The modified or updated video stream excluding the encoded representation of the picture is then forwarded towards the decoder in step S47.

If the layer identifier of the reference picture instead indicates a higher layer than the layer identifier of the picture in step S45, the method continues to step S47 where the encoded representation of the picture can be forwarded even if a reference picture defined by its buffer description information has not previously been forwarded to the decoder. In this case, the decoder can determine, as discussed in connection with step S7 in FIG. 3, that the missing picture has been intentionally removed.

S43 and S44 of FIG. 13 are preferably performed for each reference picture defined by the retrieved buffer description information.

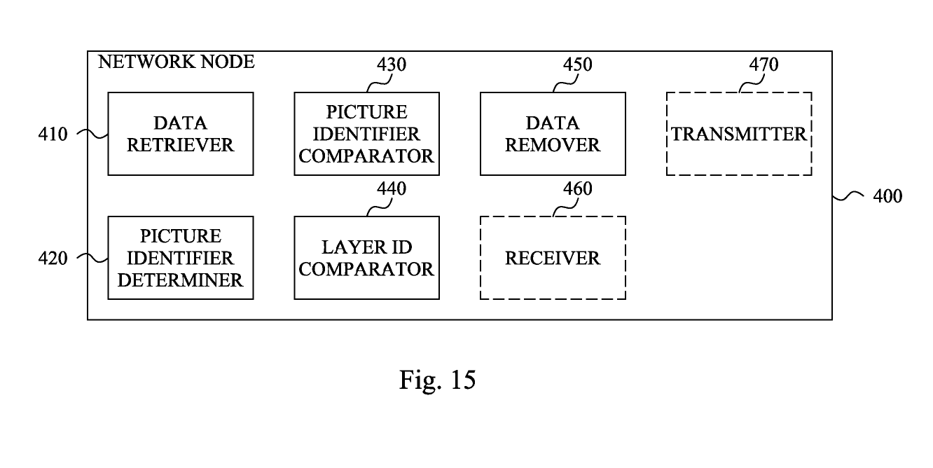

FIG. 15 is a schematic block diagram of a device, represented by a network node 400, configured to process a video stream comprising encoded representations of pictures. The network node 400 comprises a data retriever 410 configured to retrieve a picture identifier and a layer identifier from an encoded representation of a picture in the video stream. The data retriever 410 is further configured to retrieve buffer description information defining at least one reference picture identifier from the encoded representation of the picture.

A picture identifier determiner 420 is provided in the network node and is configured to determine a picture identifier identifying a reference picture as decoding reference for the picture and/or for a subsequent picture of the video stream. The picture identifier determiner 420 determines the picture identifier based on the buffer description information as previously disclosed herein in connection with the picture identifier determiner of FIG. 11.

The network node 400 also comprises a picture identifier comparator 430 configured to compare the picture identifier determined by the picture identifier determiner 420 with picture identifiers retrieved from encoded representations of pictures of the video stream previously forwarded and transmitted by a transmitter 470 of the network node 400. If the picture identifier determined by the picture identifier determiner 420 is not equal to any of the picture identifiers retrieved from previously forwarded encoded representations a layer identifier comparator 440 compares a layer identifier of the reference picture, as obtained based on the retrieved buffer description information, with the layer identifier retrieved by the data retriever 410 for the current picture.

If the layer identifier comparator 440 concludes that the layer identifier of the reference picture indicates a lower layer or an equal layer as compared to the layer identifier of the picture a data remover 450 is configured to remove the current encoded representation of the picture from the video stream.

The network node 400 preferably also comprises a receiver 460 configured to receive encoded representations of pictures of the video stream, such as from an encoder. The previously mentioned transmitter 470 is configured to forward or transmit encoded representation of the video stream to the decoder, though omitting those encoded representations that are removed by the data remover 450.

The units 410 to 470 of the network node 400 could be implemented at least partly in software. In such an embodiment, the network node 400 comprises a processor (not shown) configured to process code means of a computer program stored in a memory (not shown). The code means causes, when run on the processor, the processor to perform the functions of the units 410 to 470 disclosed in the foregoing.

The processor could be a general purpose or specially adapted computer, processor or microprocessor, such as a central processing unit (CPU). The software includes computer program code elements or software code portions effectuating the operation of at least data retriever 410, the picture identifier determiner 420, the picture identifier comparator 430, the layer identifier comparator 440 and the data remover 450 of FIG. 15.

The program may be stored in whole or part, on or in one or more suitable volatile computer readable media or data storage means, such as RAM, or one or more non-volatile computer readable media or data storage means, such as magnetic disks, CD-ROMs, DVD disks, hard discs, in ROM or flash memory. The data storage means can be a local data storage means or is remotely provided, such as in a data server. The software may thus be loaded into the operating memory of a computer or equivalent processing system for execution by a processor. The computer/processor does not have to be dedicated to only execute the above-described functions but may also execute other software tasks. A non-limiting example of program code used to define the network node include single instruction multiple data (SIMD) code.

Alternatively the network node can be implemented in hardware. There are numerous variants of circuitry elements that can be used and combined to achieve the functions of the units 410-470 of the network node 400 in FIG. 15. Such variants are encompassed by the embodiments. Particular examples of hardware implementation of the decoder 100 is implementation in digital signal processor (DSP) hardware and integrated circuit technology, including both general-purpose electronic circuitry and application-specific circuitry.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method of decoding an encoded representation of a picture of a video stream of multiple pictures comprising:
retrieving buffer description information defining at least one reference picture from said encoded representation of said picture;
determining, based on said buffer description information, a picture identifier identifying a reference picture of said at least one reference picture as decoding reference for said picture or for a subsequent picture of said video stream;
determining said reference picture identified by said picture identifier as missing if said picture identifier is not equal to any picture identifier of reference pictures stored in a decoded picture buffer;
comparing, if said reference picture identified by said picture identifier is determined as missing, a layer identifier of said picture with a layer identifier, retrieved based on said buffer description information, of said reference picture identified by said picture identifier; and
performing at least one of:
determining said reference picture identified by said picture identifier as unintentionally lost if said layer identifier of said reference picture identified by said picture identifier indicates a lower layer or an equal layer than said layer identifier of said picture; and
determining said reference picture identified by said picture identifier as intentionally removed if said layer identifier of said reference picture identified by said picture identifier indicates a higher layer than said layer identifier of said picture.

2. The method according to claim 1, further comprising preventing generation of a non-existing reference picture in said decoded picture buffer if said layer identifier of said reference picture identified by said picture identifier indicates a higher layer than said layer identifier of said picture.

3. The method according to claim 1, further comprising generating a non-existing reference picture in said decoded picture buffer if said layer identifier of said reference picture identified by said picture identifier indicates a lower layer or an equal layer than said layer identifier of said picture.

4. The method according to claim 3, further comprising storing said non-existing reference picture in said decoded picture buffer.

5. The method according to claim 3, wherein generating said non-existing reference picture comprises assigning said picture identifier and said layer identifier retrieved based on said buffer description information to said non-existing reference picture.

6. The method according to claim 3, wherein generating said non-existing reference picture is performed prior to decoding said picture.

7. The method according to claim 1, further comprising performing reference picture list initialization by ordering reference pictures in a reference picture list according to an order that said buffer description information defines, wherein said reference picture determined as intentionally removed is excluded from said reference picture list initialization.

8. The method according to claim 1, wherein
comparing said layer identifier comprises comparing, if said reference picture identified by said picture identifier is determined as missing, a temporal layer identifier of said picture with a temporal layer identifier, retrieved based on said buffer description information, of said reference picture identified by said picture identifier; and further comprising:
performing at least one of:
determining said reference picture identified by said picture identifier as unintentionally lost if said temporal layer identifier of said reference picture identified by said picture identifier is lower than or equal to said temporal layer identifier of said picture; and
determining said reference picture comprises determining said reference picture identified by said picture identifier as intentionally removed if said temporal layer identifier of said reference picture identified by said picture identifier is higher than said temporal layer identifier of said picture.

9. A decoder configured to decode an encoded representation of a picture of a video stream of multiple pictures, comprising:
a data retriever configured to retrieve buffer description information defining at least one reference picture from said encoded representation of said picture;
a picture identifier determiner configured to determine, based on said buffer description information, a picture identifier identifying a reference picture of said at least one reference picture as decoding reference for said picture or for a subsequent picture of said video stream;
a picture determiner configured to determine said reference picture identified by said picture identifier as missing if said picture identifier is not equal to any picture identifier of reference pictures stored in a decoded picture buffer;
a layer identifier comparator configured to compare, if said reference picture identified by said picture identifier is determined as missing by said picture determiner, a layer identifier of said picture with a layer identifier, retrieved based on said buffer description information, of said reference picture identified by said picture identifier; and
a generator controller configured to perform at least one of:
determine said reference picture identified by said picture identifier as unintentionally lost if said layer identifier of said reference picture identified by said picture identifier indicates a lower layer or an equal layer than said layer identifier of said picture; and
determine said reference picture identified by said picture identifier as intentionally removed if said layer identifier of said reference picture identified by said picture identifier indicates a higher layer than said layer identifier of said picture.

10. The decoder according to claim 9, wherein said generator controller is configured to prevent a picture generator from generating a non-existing reference picture in said decoded picture buffer if said layer identifier of said reference picture identified by said picture identifier indicates a higher layer than said layer identifier of said picture.

11. The decoder according to claim 9, wherein said generator controller is configured to control a picture generator to generate a non-existing reference picture in said decoded picture buffer if said layer identifier of said reference picture identified by said picture identifier indicates a lower layer or an equal layer than said layer identifier of said picture.

12. The decoder according to claim 11, further comprising a buffer manager configured to store said non-existing reference picture in said decoded picture buffer.

13. The decoder according to claim 11, wherein said picture generator is configured to assign said picture identifier and said layer identifier retrieved based on said buffer description information to said non-existing reference picture.

14. The decoder according to claim 11, wherein said picture generator is configured to generate said non-existing reference picture prior to said decoder decoding said picture.

15. The decoder according to claim 9, further comprising a list manager configured to perform reference picture list initialization by ordering reference pictures in a reference picture list according to an order that said buffer description information defines, wherein said reference picture determined as intentionally removed is excluded from said reference picture list initialization.

16. The decoder according to claim 9, wherein
said layer identifier comparator is configured to compare, if said reference picture identified by said picture identifier is determined as missing by said picture determiner, a temporal layer identifier of said picture with a temporal layer identifier, retrieved based on said buffer description information, of said reference picture identified by said picture identifier; and
said generator controller is configured to perform at least one of:
determine said reference picture identified by said picture identifier as unintentionally lost if said temporal layer identifier of said reference picture identified by said picture identifier is lower than or equal to said temporal layer identifier of said picture; and
determine said reference picture identified by said picture identifier as intentionally removed if said temporal layer identifier of said reference picture identified by said picture identifier is higher than said temporal layer identifier of said picture.

17. A receiver comprising:
an input section configured to receive encoded representations of multiple pictures of a video stream;
a decoder configured to decode an encoded representation of a picture of a video stream of multiple pictures, comprising:
a data retriever configured to retrieve buffer description information defining at least one reference picture from said encoded representation of said picture;
a picture identifier determiner configured to determine, based on said buffer description information, a picture identifier identifying a reference picture of said at least one reference picture as decoding reference for said picture or for a subsequent picture of said video stream;
a picture determiner configured to determine said reference picture identified by said picture identifier as missing if said picture identifier is not equal to any picture identifier of reference pictures stored in a decoded picture buffer;
a layer identifier comparator configured to compare, if said reference picture identified by said picture identifier is determined as missing by said picture determiner, a layer identifier of said picture with a layer identifier, retrieved based on said buffer description information, of said reference picture identified by said picture identifier; and
a generator controller configured to perform at least one of:
determine said reference picture identified by said picture identifier as unintentionally lost if said layer identifier of said reference picture identified by said picture identifier indicates a lower layer or an equal layer than said layer identifier of said picture;
determine said reference picture identified by said picture identifier as intentionally removed if said layer identifier of said reference picture identified by said picture identifier indicates a higher layer than said layer identifier of said picture; and
an output section configured to output decoded pictures of said video stream.

18. A decoder comprising:
an input section configured to receive encoded representations of multiple pictures of a video stream;
a processor configured to process code of a computer program stored in a memory, said code causing, when run on said processor, said processor to:
retrieve buffer description information defining at least one reference picture from said encoded representation of said picture;
determine, from said buffer description information, a picture identifier identifying a reference picture of said at least one reference picture as decoding reference for said picture or for a subsequent picture of said video stream;
determine said reference picture identified by said picture identifier as missing if said picture identifier is not equal to any picture identifier of reference pictures stored in a decoded picture buffer;
compare, if said reference picture identified by said picture identifier is determined as missing, a layer identifier of said picture with a layer identifier, retrieved based on said buffer description information, of said reference picture identified by said picture identifier; and
perform at least one of:
determine said reference picture identified by said picture identifier as unintentionally lost if said layer identifier of said reference picture identified by said picture identifier indicates a lower layer or an equal layer than said layer identifier of said picture; and
determine said reference picture identified by said picture identifier as intentionally removed if said layer identifier of said reference picture identified by said picture identifier indicates a higher layer than said layer identifier of said picture; and
an output section configured to output decoded pictures of said video stream.

19. A method of processing a video stream comprising encoded representations of pictures comprising:
retrieving, from an encoded representation of a picture in said video stream, a picture identifier and a layer identifier of said picture;
retrieving buffer description information defining at least one reference picture from said encoded representation of said picture;
determining, based on said buffer description information, a picture identifier identifying a reference picture of said at least one reference picture as decoding reference for said picture or for a subsequent picture of said video stream;
comparing said picture identifier identifying said reference picture with picture identifiers retrieved from previously forwarded encoded representations of pictures in said video stream;
comparing, if said picture identifier identifying said reference picture is not equal to any of said picture identifiers retrieved from previously forwarded encoded representations of pictures in said video stream, a layer identifier of said reference picture with said layer identifier of said picture; and
removing said encoded representation of said picture from said video stream if said layer identifier of said reference picture indicates a lower layer or an equal layer than said layer identifier of said picture.

20. The method according to claim 19, further comprising:
receiving said video stream from an encoder; and
forwarding said video stream to a decoder.

21. A network node configured to process a video stream comprising encoded representations of pictures, said network node comprising:
a data retriever configured to retrieve, from an encoded representation of a picture in said video stream, a picture identifier and a layer identifier of said picture and buffer description information defining at least one reference picture from said encoded representation of said picture;
a picture identifier determiner configured to determine, based on said buffer description information, a picture identifier identifying a reference picture of said at least one reference picture as decoding reference for said picture or for a subsequent picture of said video stream;
a picture identifier comparator configured to compare said picture identifier identifying said reference picture with picture identifiers retrieved from previously forwarded encoded representations of pictures in said video stream;
a layer identifier comparator configured to compare, if said picture identifier identifying said reference picture is not equal to any of said picture identifiers retrieved from previously forwarded encoded representations of pictures in said video stream, a layer identifier of said reference picture with said layer identifier of said picture; and
a data remover configured to remove said encoded representation of said picture from said video stream if said layer identifier of said reference picture indicates a lower layer or an equal layer than said layer identifier of said picture.

22. The network node according to claim 21, further comprising:
a receiver configured to receive said video stream from an encoder; and
a transmitter configured to forward said video stream to a decoder.
